(19) United States
(12) Patent Application Publication
(10) Pub. No.: US 2017/0043280 A1
(43) Pub. Date: Feb. 16, 2017

(54) Liquid Solid Separator

(71) Applicant: Ravan Holdings, LLC, Osprey, FL (US)

(72) Inventor: Raymond Vankouwenberg, Osprey, FL (US)

(21) Appl. No.: 15/306,640

(22) PCT Filed: Apr. 20, 2015
(86) PCT No.: PCT/US15/26600

§ 371 Date: Oct. 25, 2016

Related U.S. Application Data
(60) Provisional application No. 61/984,187, filed on Apr. 25, 2014.

(51) Int. Cl. B01D 21/00; B01D 21/34; B01D 47/02; B01D 21/30; B01D 21/06

(52) U.S. Cl. CPC B01D 21/009; B01D 21/307; B01D 21/06; B01D 47/02; B01D 21/34; B01D 21/302; B01D 2247/04

(57) ABSTRACT

A liquid solids separator includes a liquid receiving tank, a cascade tank, and a settling tank fluidically connected in series. Wastewater is recycled through the tanks beginning with the liquid receiving tank and contacted with hot gas in the cascade tank to concentrate the wastewater and remove solids that settle in the settling tank.

### FIELD OF THE INVENTION

The present invention relates generally to devices for separating solids from liquids. More particularly, the invention relates to a liquid solids separator having heat exchange with hot air or hot combustion exhaust gases to concentrate the liquid stream and to separate solids from the liquid stream for disposal.

### BACKGROUND OF THE INVENTION

There exist liquid solid separators for heating wastewater to concentrate the wastewater and separate remaining solids from the concentrated wastewater for disposal. While these prior separators may meet their respective objectives, there exists a need for an improved liquid solids separator having an advantageous design that is portable and usable with a variety of heat sources.

### SUMMARY OF THE INVENTION

Embodiments of the present invention provide a liquid solid separator that is portable and can be transported to remote sites and operate using on-site boilers or waste heat source.

In general, in one aspect, a liquid solids separator is provided that includes a liquid receiving tank, a cascade tank, and a settling tank. The liquid receiving tank is connectable to a liquid source to receive and hold liquid from the liquid source. The cascade tank disposed vertically above the liquid receiving tank and includes a water channel that extends the length of the cascade tank. The water channel is fluidically connected to the liquid receiving tank for receiving liquid from the liquid receiving tank. The cascade tank further includes a hot gas inlet to receive hot gas from a hot gas supply. The settling tank disposed vertically below the cascade tank and extends along the length of the cascade tank and is fluidically connected to the cascade tank for receiving liquid and hot gas from the cascade tank. The settling tank is also fluidically connected to the liquid receiving tank by a weir opening extending between the settling tank and the liquid receiving tank for passing fluid in the settling tank to the liquid receiving tank. And an exhaust vent is fluidically connected to the settling tank for discharging hot gas received by the settling tank.

In general, in another aspect, the liquid solids separator may also include a paddle wheel disposed within the settling tank and supported at its opposite ends for rotation about an axis of rotation. A motor is operatively connected to the paddle wheel and operates to rotate the paddle wheel about the axis of rotation. First and second elongated paddles are connected to the paddle wheel diametrically opposite one another. An elongated trough extends along the length of the settling tank and a solids conveyor disposed within the elongated trough. And wherein the first and second paddles collect solids from the surface of the settling tank and deposit the collected solids in the elongated trough when the paddle wheel is driven by the motor.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic perspective view of a liquid solids separator constructed in accordance with the principles of an embodiment of the present invention;

FIG. 2 is a diagrammatic top view of the liquid solids separator of FIG. 1, illustrating various system components;

FIG. 3 is a diagrammatic perspective view with a partial cross section of the liquid solids separator of FIG. 1, illustrating a solids conveyor and a paddle wheel of the liquid solids separator;

FIG. 4 is a perspective, cross-sectional view taken of the liquid solids separator taken along line 4-4 in FIG. 2, further illustrating the solids conveyor, the paddle wheel, and a cascading water system;

FIG. 5 is a cross-sectional view taken of the liquid solids separator taken along line 5-5 in FIG. 1, further illustrating the cascading water system, the paddle wheel, and the solids conveyor;

FIG. 6 is a partial cross-sectional end view taken of the liquid solids separator taken along line 6-6 in FIG. 1, illustrating the liquid solids separator in operation;

FIG. 7 is an enlarged, partial cross-sectional view the cascading water system, illustrating a flow of heated air and liquid through a flow tube;

FIG. 8 is a schematic view of an automatic moisture control for adjusting the moisture content of discharged solids;

FIG. 9 is a schematic view of an automatic system control that operates to shut down the system based upon fluid flow;

FIG. 10 is a diagrammatic view of the liquid solids separator including a static pressure control; and

FIG. 11 is a diagrammatic view of the liquid solids separator including secondary heating.

### DETAILED DESCRIPTION OF THE INVENTION

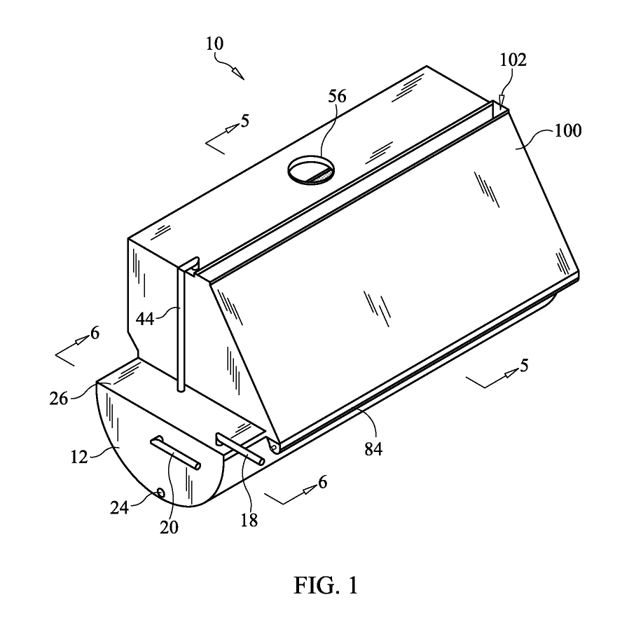

With reference to FIG. 1, there is representatively illustrated a liquid solids separator 10 that is constructed in accordance with an embodiment of the present invention. The liquid solids separator 10 may be used to separate solids from a wide variety of liquid streams, such as industrial wastewater, agricultural wastewater, run off water, landfill leachate, etc. As described herein, the liquid solids separator 10 utilizes a unique multiple tank construction including direct heat exchange with hot air or hot combustion exhaust gases to concentrate a liquid stream and to separate solids from the liquid stream for disposal. The liquid solids separator 10 is portable and can be mounted to a skid, trailer, or other movable frame for transporting to remote sites. As further described below, the liquid solids separator 10 may operate using an on-site boiler or waste heat source. Alternatively or in combination with an on-site boiler or waste heat source, the liquid solids separator 10 may operate using its own heat source, such as a boiler, an electrical heater, a solar heater, or any combination of these, for example.

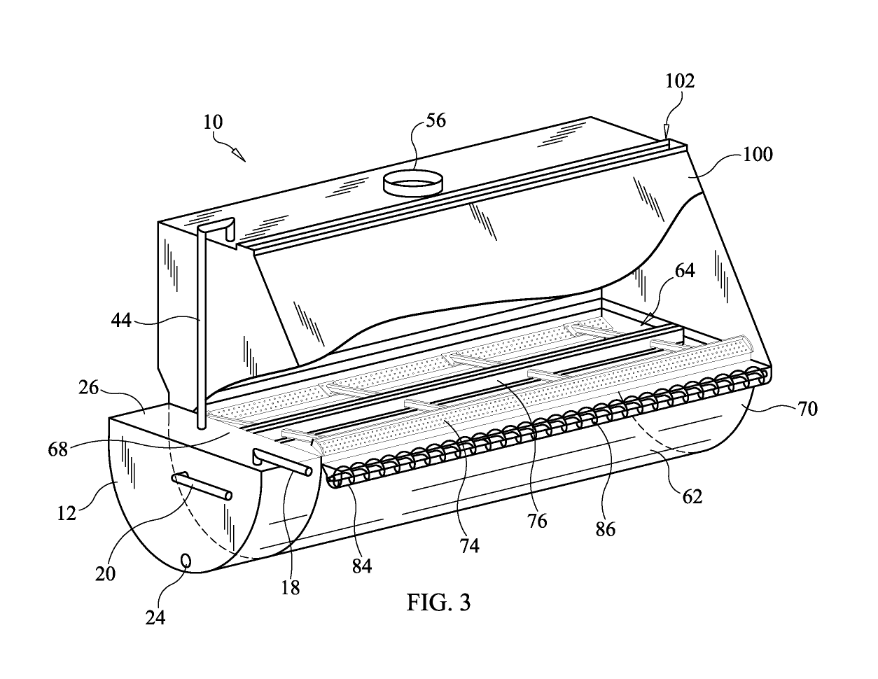

With reference to FIGS. 1-5, the liquid solids separator 10 includes a liquid receiving tank 12 for receiving liquid 14 to be treated from a liquid source 16, such as industrial wastewater, for example. The liquid 14 is pumped from the liquid source 16 into the liquid receiving tank 12 by fluid conduit 18, which is connected in fluidic communication with the liquid receiving tank. Liquid 14 may optionally be pre-heated before entering the liquid receiving tank 12. Liquid receiving tank 12 includes a safety overflow 20 that connects the liquid receiving tank to an overflow catch tank 22 or alternatively to the liquid source 16 to prevent overflowing the liquid receiving tank in the case of an operating malfunction. The liquid receiving tank 12 also includes a drain 24 disposed at a bottom end thereof to permit draining and flushing the liquid receiving tank. A panel or cover 26 is removably connected to the liquid receiving tank 12 to provide access to the interior thereof.

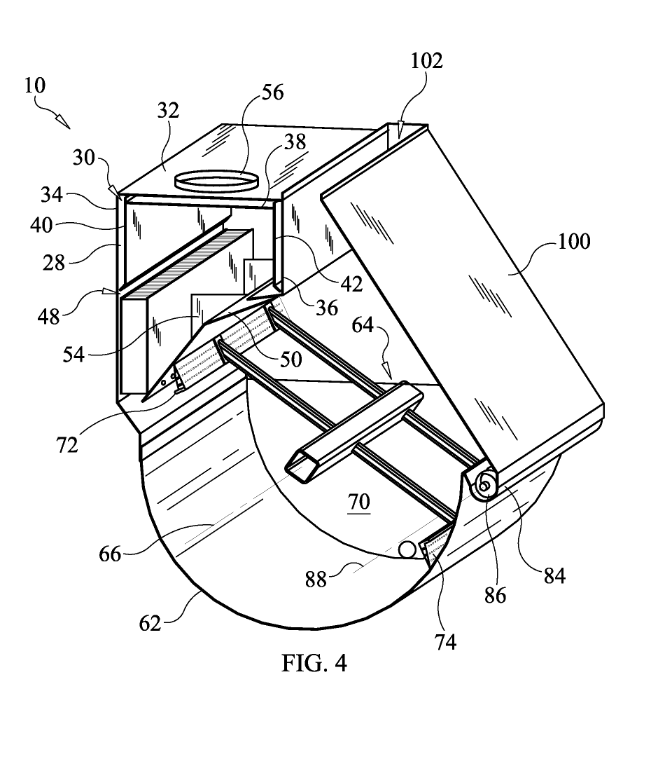

The liquid solids separator 10 further includes a cascade tank 28 (best seen in FIGS. 4-6) that is supported vertically above the liquid receiving tank 12. Cascade tank 28 is elongated and extends substantially the length of the liquid solids separator 10. Within the cascade tank 28 there is a water channel 30 that is disposed along the top and vertical sides of the cascade tank. Specifically, the water channel 30 is defined by a space created between an exterior wall of the cascade tank comprising panels 32, 34, and 36 and an upside down, U-shaped tray comprising panels 38, 40, and 42 that are inwardly spaced from panels 32, 34, and 36. Tray panels 38, 40, and 42 extend the entire length of the cascade tank. And, water channel 30 communicates with the interior of the cascade tank by longitudinally extending gaps between wall panels 34 and 36 and the bottom edges of tray panels 40 and 42.

A vertical stand pipe 44 fluidically connects the liquid receiving tank 12 with the water channel 30 of the cascade tank 28. A high temperature pump 46 is positioned within the liquid receiving tank 12 and is connected to the vertical stand pipe 44. Pump 46 is operated to pump liquid from the liquid receiving tank into the water channel 30 of the cascade tank 28.

Also disposed within the cascade tank 28 are a plurality of vertically oriented tubes 48 that are arranged side-by-side along the entire length of wall panel 34 at a position that is vertically below the bottom edge of tray panels 40 and 42. That is, the top ends of tubes 44 are disposed vertically below the bottom edges of tray panels 40 and 42. Further, wall panel 36 is bent inwardly along its bottom end at a position below the bottom edge of tray panel 42 and provides an impingement surface to direct liquid flowing outwardly from channel 36 towards tubes 46. A bottom wall panel 50 of the cascade tank 28 extends in a narrowing fashion from about wall panel 36 to the bottom ends of tubes 48, where the bottom wall panel is joined and sealed to the exterior wall of tubes 48 along a longitudinally extending interface edge between the bottom wall panel and the tubes. The upper end of the bottom wall panel 50 is spaced from wall panel 36, thereby forming a longitudinally extending gap 52 between the bottom wall panel and wall panel 36. A plurality of vertically oriented and longitudinally spaced baffles 54 are connected to and extend between tubes 48 and bottom wall panel 50 and provide additional support.

The cascade tank 28 further includes a hot air/gas inlet 56 that communicates with the interior of the cascade tank at an interiorly positioned side of the water channel 30. The hot air inlet 56 is connected to a source of hot air, such as, for example, a fuel-fired boiler 58 to receive hot combustion gas 60 from the boiler within the cascade tank 28. Other sources of hot combustion gas may be utilized. Additionally, the rather than hot combustion gas, other sources of hot air may be utilized. The cascade tank 28 may be further include secondary air inlets (not shown) to supplement the flow of hot air into the cascade tank 28 with ambient air surrounding the cascade tank. One or more blowers may be connected to the secondary air inlets and operated to pull or push the ambient air through the secondary air inlets and into the cascade tank 28. Various control means may be used to control the operation of the secondary air inlet blowers.

The liquid solids separator further includes a semi-circular shaped settling tank 62 that is positioned vertically below the cascade tank 28 and that extends longitudinally along the entire length of the cascade tank. The cascade tank 28 and the settling tank 62 are fluidically connected by the plurality of tubes 48 that extend along the length of the cascade tank. As will be described in further detail below, fluid and hot air within the cascade tank is caused to flow downwardly through the plurality of tubes 48 and into the settling tank 62.

A paddle wheel 64 is disposed within the settling tank 62. The paddle wheel 64 extends longitudinally within the settle tank 62 and includes an elongated hub 76 that is supported at its opposite ends for rotation in a counter-clockwise direction about axis 66. As illustrated, the elongated hub 76 is supported at its opposite ends by end walls 68 and 70. A variable speed motor 90 is operatively connected to the paddle wheel, for example by hub 76, and operates to drive or rotate the paddle wheel. The paddle wheel 64 further includes at least two diametrically opposed and elongated paddles or collectors 72, 74 that are supported at a radial distance from the elongated hub 76. Paddles 72, 74 also extend the length of the settling tank 62 and are positioned and configured to scrape or otherwise remove and collect solids 80 that have settled at the bottom of the settling tank or have adhered to the sidewall 82 of the settling tank as the paddle wheel 64 is rotated.

An elongated trough 84 extends along the longitudinal length of the settling tank 62. As illustrated, the trough 84 is formed integral with the settling tank 62, but could be formed separately from the settling tank. A solids conveyor, such as the illustrated auger 86 is disposed within the elongated trough 84 and is supported for rotation about axis 88 at its opposite ends by end walls 68 and 70. A variable speed motor 92 is operatively connected to the auger 86 and operates to drive or rotate the auger. As is further discussed below, solids 80 that are collected by collectors 72, 74 of the paddle wheel 64 are deposited into the trough 84 when the collectors rotate pass the trough. Those solids 80 are then conveyed by the auger 86 along the length of the trough 84 where they are then discharged as discharge solids 94 at the end of the trough.

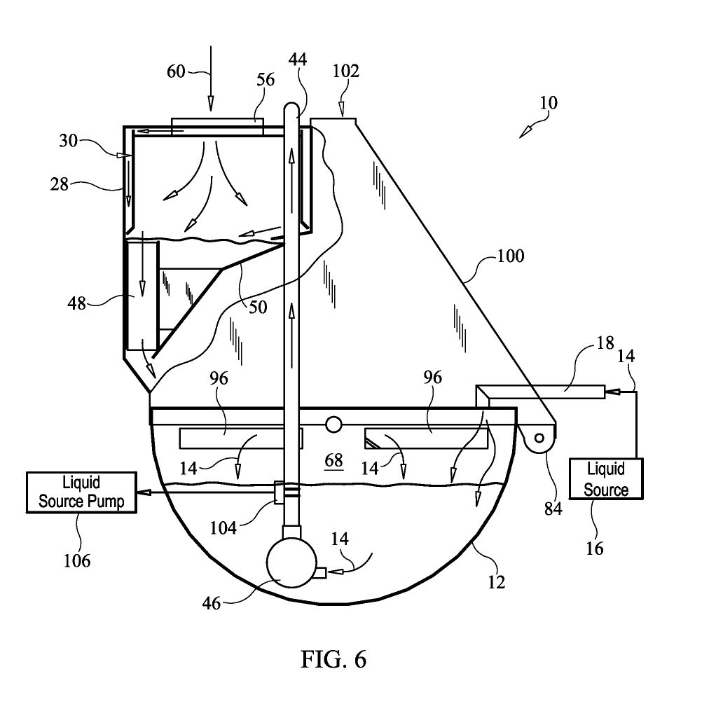

The settling tank 62 includes one or more water overflow weir openings 96 that are formed through end wall 68 and that fluidically communicate with the liquid receiving tank 12 (best seen in FIG. 6). That is, as the settling tank 62 fills with liquid 14, the liquid flows from the settling tank back to the liquid receiving tank 12 via weir openings 96. Weir openings 96 are positioned above the operating water level of the liquid receiving tank 12 such that liquid only flows from the settling tank 62 into the liquid receiving tank. The settling tank 62 also includes a drain 98 disposed at a bottom end thereof to permit draining and flushing the settling tank.

The liquid solids separator 10 further includes an exhaust hood 100 that is connected to and encloses the settling tank 62. The exhaust hood 100 includes an elongated exhaust vent or opening 102 that extends longitudinally along the length of the exhaust hood. The exhausting opening 102 permits discharging from the settling tank 62 to the atmosphere water vapor that is produced by the evaporation of liquid 14 and the hot air/combustion gases 60 that flow into the settling tank from the cascade tank 28. While not illustrated, one or more dampers may be positioned across the exhausting opening to control the speed and or volume of air/gases flowing outwardly through the exhausting opening.

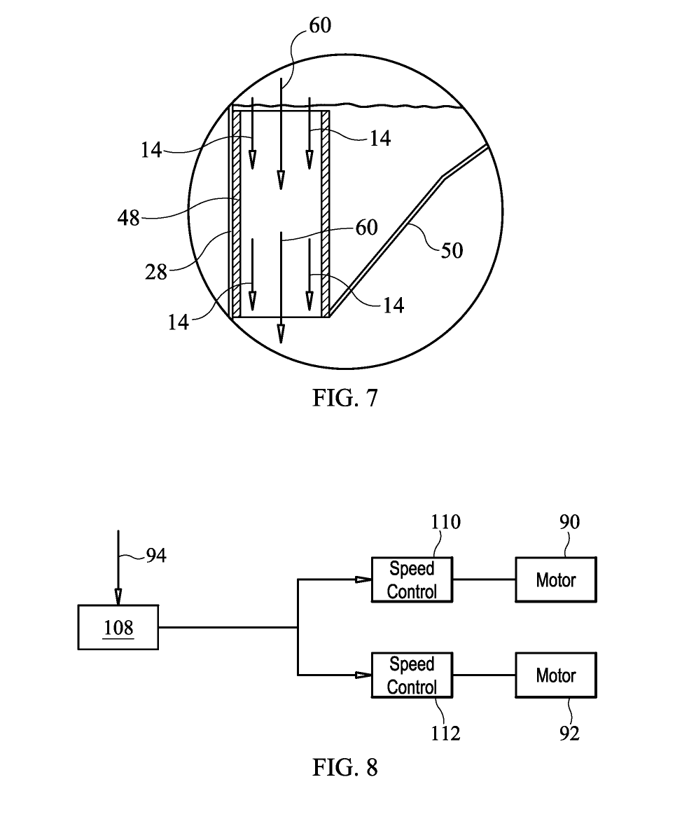

With further reference to FIGS. 6 and 7, in operation, it can now be understood;

feed water or wastewater 14 from a source of wastewater 16 is pumped into the liquid receiving tank 12. A liquid level sensor 104 is disposed, for example, within the liquid receiving tank 12, and is operatively connected to the wastewater feed pump 106. The liquid level sensor 104 operates to sense the fluid level of the liquid receiving tank 12. When a low level is sensed by the liquid level sensor 104, the wastewater feed pump 106 is activated to pump wastewater 14 into the liquid receiving tank until 12 the desired liquid level is sensed by the liquid level sensor, at which time the wastewater feed pump is deactivated. This process cycles continuously during operation of the liquid solids separator 10 to ensure the liquid receiving tank 12 has a constant supply of wastewater 14.

Pump 46 operates to continuously pump wastewater 14 from the liquid receiving tank 12 through the vertical stand pipe 44 and into water channel 30 of the cascade tank 28. The wastewater 14, then flows through the water channel, along the top and side walls of the cascade tank 28 and then discharged into the cascade tank. The wastewater 14 fills the cascade tank 28 until the level reaches the top of the array of the vertical tubes 48. Then, the wastewater 14 flows over the tops and downwardly through the array of vertical tubes 48 and into the settling tank 62. Additionally, a small fraction of the wastewater 14 flows through a series of spaced holes (not shown) that are formed through and longitudinally along the bottom wall 50 of the cascade tank 28 and into the settling tank 62.

Concurrently, heated air from a heat engine, such as, for example, hot combustion gas 60 from a boiler (not shown) flows into the cascade tank 28 through the hot air/gas inlet 56. In the cascade tank 28, the hot combustion gas 60 heats the wastewater 14 as it flows through water channel 30. Further, in the cascade tank 28, the hot combustion gas 60 is caused to be entrained and flow with the wastewater 14 as the wastewater flows through the vertical tubes 48 and into the settling tank 62. The hot combustion gas 60 continues to heat the wastewater 14 as it flows together with the wastewater into the settling tank 62. Additionally, the hot combustion gas 60 is scrubbed of particulates by the wastewater 14 as the hot combustion gas flows along with the wastewater from the cascade tank 28 into the settling tank 62.

Once in the settling tank 62, the hot combustion gas 60 separates from the wastewater 14 and then flows outwardly from the settling tank through the exhaust opening 102 where it is vented to atmosphere. Additionally, water vapor that is evaporated from the heated wastewater 14 also flows outwardly from the settling tank through the exhaust opening 102. Further, as wastewater 14 fills the settling tank 62, it is recycled back to the liquid receiving tank 12 via the overflow weir openings 96 and pumped back into the cascade tank 28. That is, the wastewater 14 is continuously recycled through the liquid solids separate to concentrate the wastewater and to remove solids from the wastewater.

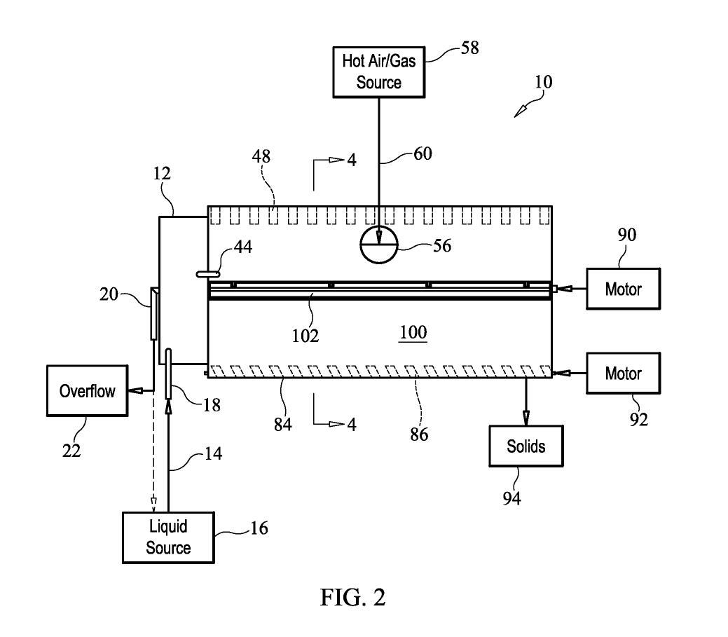

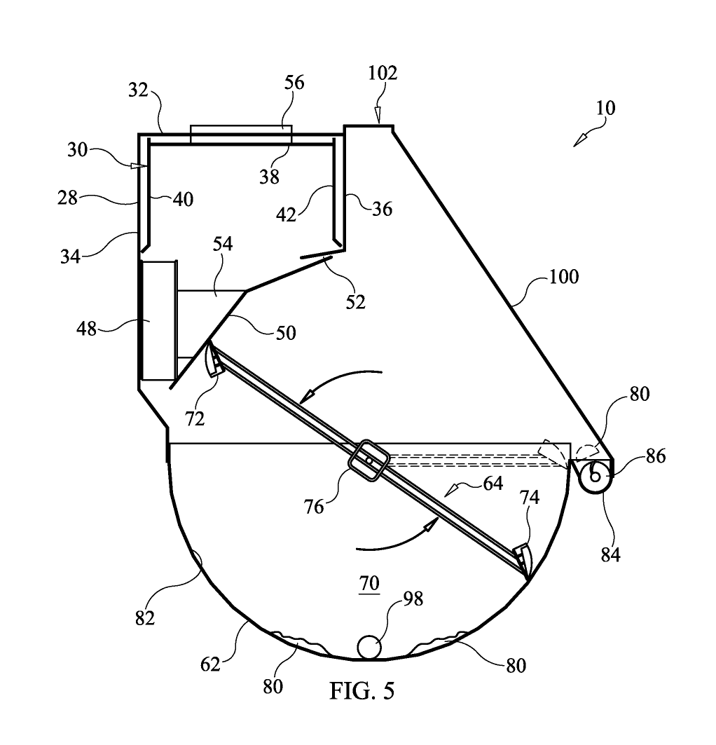

Further within the settling tank 62, the rotating paddle wheel 64 continuously collects solids 80 that have settled along the bottom of the settling tank and deposits the solids in the elongated trough 84 (FIG. 5). Once in the elongated trough 84, the solids are transported by the auger 86 to the end of the trough, where the solids are then discharged (FIG. 2). The moisture content of the discharged solids 94 can be manually determined and adjusted by changing the speed of motor 90 driving the paddle wheel, the speed of motor 92 driving the auger, or the speed of both. Alternative, the moisture content of the discharged solids 94 may be automatically adjusted.

With reference to FIG. 8, a moisture content sensor 108 may be used to monitor the moisture content of the discharged solids 94. The moisture content sensor 108 is operatively connected to speed control 110 and 112 of the paddle wheel motor 90 and the auger motor 92, respectively. The speed controls 110 and 112 operate to adjust the speeds of the paddle wheel motor 90 and the auger wheel motor 92 to adjust the moisture content of the discharged solids 94 as determined by the moisture sensor 94.

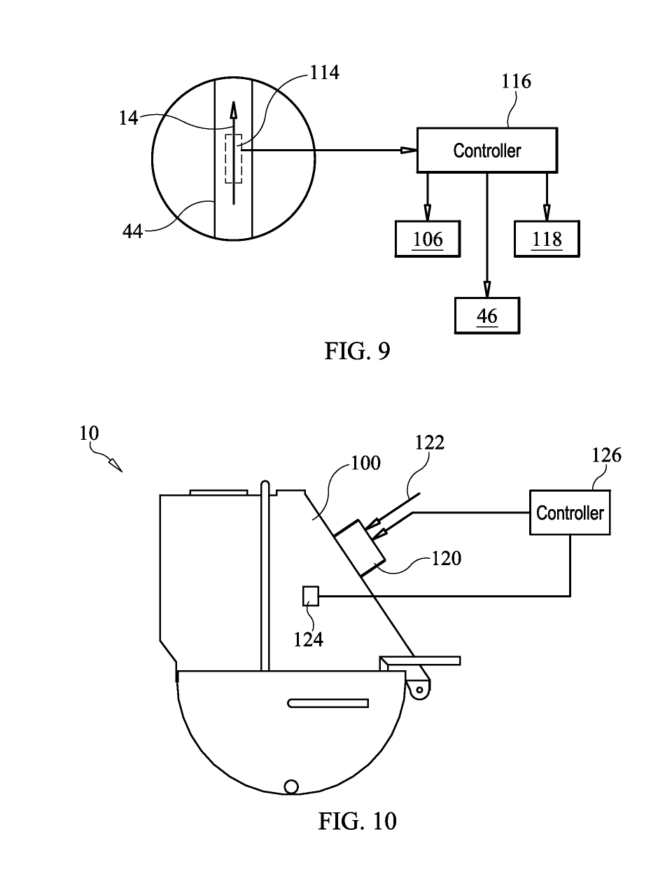

While one embodiment has been described in detail, other embodiments are possible. For example, with reference to FIG. 9, a fluid flow sensor 114 may be used to monitor the flow of fluid 14 through stand pipe 44. The output of the flow sensor 114 is operatively connected to a controller 116, which is operatively connected to one or more components of the system, for example, the liquid source pump 106, the fluid pump 46, and boiler 118. If the controller 116 determines fluid is not flowing through pipe 44 as monitored by the flow sensor, the controller operates to shut down the system, e.g., the controller shuts down pumps 46 and 106 and the boiler 118.

In an another embodiment, the liquid solids separator 10 may have a static air pressure system that operates to control the static air pressure of the system to be within operating limits of the heat source, such as the boiler, for example. The static air pressure system includes one or more variable speed blowers 120 that are operatively coupled to the exhaust hood 100 to provide a flow of air 122 into the exhaust hood from the ambient air surrounding the liquids solid separator 10 to control the static air pressure within the exhaust hood. A pressure sensor 124 may be provided to sense or monitor the air pressure within the exhaust hood 100. A controller 126 is operatively connected to the pressure sensor 124 and operates to control blower 120 to adjust the static air pressure within the exhaust hood 110 as determined by the pressure sensor.

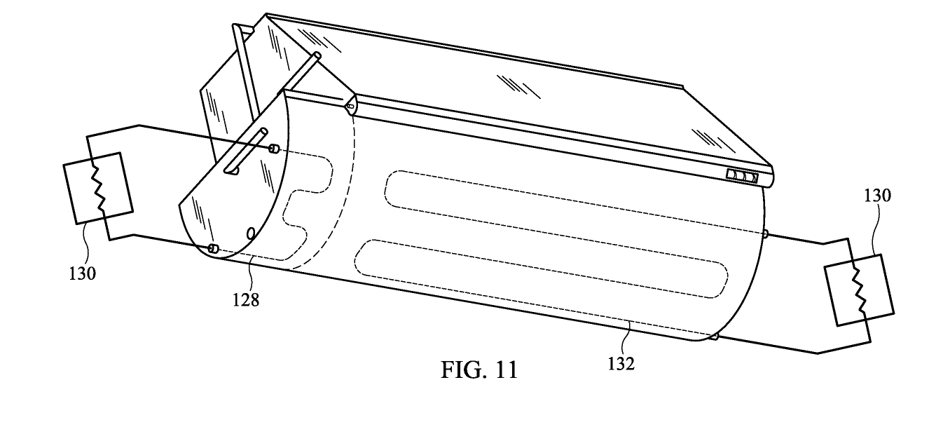

In another embodiment, secondary heat sources may be used to heat the wastewater for treatment. For example, referring to FIG. 11, either the liquid receiving tank 12, the settling tank 62, or both can be fitted with a heat jack or heat pipes. As shown, the liquid receiving tank 12 includes heat pipes 128 which carry a heated medium circulated through a heater, such as boiler 130, for example. Boiler 130 may be the same boiler that provides the hot combustion gas to the cascade tank or could be a separate boiler. Likewise, as shown, the settling tank includes heat pipes 132 which carry a heated medium circulated through a heater, such as boiler 130, for example. A solar heater could be substituted for the boiler. Alternatively, electrical heating elements could be substituted for the heat pipes or used in addition to the heat pipes to supplement heat.

A number of embodiments of the present invention have been described. Nevertheless, it will be understood that various modifications may be made without departing from the spirit and scope of the invention. Accordingly, other embodiments are within the scope of the following claims.

What is claimed is:

1. A liquid solids separator comprising:
a liquid receiving tank, said liquid receiving tank being connectable to a liquid source to receive and hold liquid from said liquid source;
a cascade tank, said cascade tank disposed vertically above said liquid receiving tank;
said cascade tank having a water channel that extends the length of said cascade tank, said water channel fluidically connected to said liquid receiving tank for receiving liquid from said liquid receiving tank;
said cascade tank further having a hot gas inlet to receive hot gas from a hot gas supply;
a settling tank, said settling tank disposed vertically below said cascade tank and extending along the length of said cascade tank, said settling tank fluidically connected to said cascade tank for receiving liquid and hot gas from said cascade tank;
said settling tank fluidically connected to said liquid receiving tank by a weir opening extending between said settling tank and said liquid receiving tank for passing fluid in said settling tank to said liquid receiving tank; and
an exhaust vent fluidically connected to said settling tank for discharging hot gas received by said settling tank.

2. The liquid solids separator of claim 1, wherein said hot gas inlet extends through said water channel.

3. The liquid solids separator of claim 1, wherein said exhaust vent extends along the length of said settling tank.

4. The liquid solids separator of claim 1, further comprising:
a fluid overflow fluidically connected to said liquid receiving tank.

5. The liquid solid separator of claim 1, wherein said settling tank is fluidically connected to said cascade tank along the length of said settling tank.

6. The liquid solids separator of claim 1, further comprising:
a plurality of vertical tubes disposed within said cascade tank and arranged side-by-side along the length of said cascade tank and along the fluid connection between said cascade tank and said settling tank.

7. The liquid solids separator of claim 1, further comprising:
a paddle wheel disposed within said settling tank and supported at its opposite ends for rotation about an axis of rotation;
a motor operatively connected to said paddle wheel and operating to rotate said paddle wheel about said axis of rotation;
first and second elongated paddles connected to said paddle wheel and diametrically opposite one another;
an elongated trough extending along the length of said settling tank;
a solids conveyor disposed within said elongated trough; and
wherein said first and second paddles collect solids from the surface of said settling tank and deposit the collected solids in said elongated trough when said paddle wheel is driven by said motor.

8. The liquid solids separator of claim 1, further comprising:
a U-shaped tray disposed within said cascade tank at a spaced distance from panels of said cascade thereby creating a space between said U-shaped tray and said panels of said cascade tank, and
wherein said space provides said water channel.

9. A liquid solids separator comprising:
a liquid receiving tank, said liquid receiving tank connected to a liquid source and receiving and holding a quantity of liquid from said liquid source;
a cascade tank, said cascade tank disposed vertically above said liquid receiving tank;
said cascade tank having a water channel that extends the length of said cascade tank, said water channel fluidically connected to said liquid receiving tank for receiving liquid from said liquid receiving tank;
said cascade tank having a hot gas inlet connected to hot gas supply to receive hot gas from said hot gas supply;
a settling tank, said settling tank disposed vertically below said cascade tank and extending along the length of said cascade tank, said settling tank fluidically connected to said cascade tank for receiving liquid and hot gas from said cascade tank;
said settling tank fluidically connected to said liquid receiving tank by a weir opening extending between said settling tank and said liquid receiving tank for passing fluid in said settling tank to said liquid receiving tank;
an exhaust vent fluidically connected to said settling tank for discharging hot gas received by said settling tank;
a paddle wheel disposed within said settling tank and supported at its opposite ends for rotation about an axis of rotation;
a motor operatively connected to said paddle wheel and operating to rotate said paddle wheel about said axis of rotation;
first and second elongated paddles connected to said paddle wheel and diametrically opposite one another;
an elongated trough extending along the length of said settling tank;
a solids conveyor disposed within said elongated trough; and
wherein said first and second paddles collect solids from the surface of said settling tank and deposit the collected solids in said elongated trough when said paddle wheel is driven by said motor.

10. The liquid solids separator of claim 9, further comprising:
a U-shaped tray disposed within said cascade tank at a spaced distance from panels of said cascade thereby creating a space between said U-shaped tray and said panels of said cascade tank, and
wherein said space provides said water channel.

11. The liquid solids separator of claim 10, further comprising:
a plurality of vertical tubes disposed within said cascade tank and arranged side-by-side along the length of said cascade tank and along the fluid connection between said cascade tank and said settling tank, each of said vertical tubes having a top end and bottom end; and
wherein the top end of each vertical tube is positioned vertically bellow bottom edges of said U-shaped tray.

12. The liquid solids separator of claim 11, wherein:
said cascade tank has a bottom wall panel that extends in a narrowing fashion from a sidewall panel of said cascade tank to bottom ends of said vertical tubes, said bottom wall panel being joined and sealed to said vertical tubes along a longitudinally extending interface edge between the bottom wall panel and said vertical tubes.

13. The liquid solids separator of claim 12, wherein:
an upper end of said bottom wall panel is spaced from said sidewall panel thereby forming a gap longitudinally extending gap between said bottom wall panel and said sidewall panel.

14. The liquid solids separator of claim 13, further comprising:
a plurality of vertically oriented baffles connected to and extending between said bottom wall panel and said vertical tubes.

15. The liquid solid separator of claim 9, wherein said settling tank is fluidically connected to said cascade tank along the length of said settling tank.

16. The liquid solids separator of claim 9, wherein said hot gas inlet extends through said water channel.

17. The liquid solids separator of claim 9, wherein said exhaust vent extends along the length of said settling tank.

18. The liquid solids separator of claim 9, further comprising:
a fluid overflow fluidically connected to said liquid receiving tank.
